(19) United States
(12) Patent Application Publication
(10) Pub. No.: US 2017/0086944 A1
(43) Pub. Date: Mar. 30, 2017

(54) ORTHODONTIC LIGATURE

(71) Applicant: James HULWI, Mankato, MN (US)

(72) Inventor: James HULWI, Mankato, MN (US)

(21) Appl. No.: 15/274,136

(22) Filed: Sep. 23, 2016

Related U.S. Application Data
(60) Provisional application No. 62/232,707, filed on Sep. 25, 2015.

(51) Int. Cl. A61C 7/12; A61C 7/30; A44C 27/00; A44C 15/00

(52) U.S. Cl. CPC A61C 7/125; A44C 15/007; A61C 7/303; A44C 27/00

(57) ABSTRACT

An orthodontic ligature has a decorative member, a ligature member, and an optional sticker member. The decorative member is connected to the ligature member and extents over the ligature member. After the ligature is installed to a bracket, the decorative member can at least partially cover the bracket. The decorative member and/or the optional sticker member can be configured to have various colors, shapes, patterns, etc., so as to provide cosmetic, attractive, and/or protective effects.

### FIELD

This disclosure relates generally to orthodontics. In particular, the disclosure relates to an orthodontic ligature.

### BACKGROUND

Various devices are used to correct malpositioned teeth in orthodontics. One commonly used device is braces. With braces, orthodontic brackets are affixed to the teeth. Archwires are inserted into the brackets, and apply forces to move the malpositioned teeth to desired positions. Ligatures hold the archwires in contact with the brackets, and may provide tensile forces between the teeth. These devices are normally exposed and conspicuous when viewed from the front of the teeth.

### SUMMARY

An orthodontic ligature as described in this specification includes a ligature member and a decorative member.

In some embodiments, the decorative member is directly connected to the ligature member.

In some embodiments, the orthodontic ligature may further include a connection member that connects the ligature member to the decorative member.

In some embodiments, the decorative member extends over and at least partially overlaps with the ligature member.

In some embodiments, when the ligature member is installed to a bracket bonded to a tooth, the decorative member is disposed in front of the bracket relative to the tooth, and at least partially covers a bracket and archwire. The ligature member can hold the archwire in contact with the bracket.

In some embodiments, the decorative member can be formed into different shapes, colors, and patterns. In some embodiments, the decorative member can provide a cosmetic and/or attractive effect.

In some embodiments, the decorative member may protect the bracket and/or the archwire from breakage.

### BRIEF DESCRIPTION OF THE DRAWINGS

References are made to the accompanying drawings that form a part of this disclosure, and which illustrate embodiments in which the systems and methods described in this specification can be practiced.

FIG. 1 is a schematic front view of an orthodontic assembly including a bracket, an archwire, and a ligature, according to some embodiments.

FIG. 2 is a schematic view of the orthodontic assembly in FIG. 1, according to some embodiments.

FIG. 3 is a side view of the installed ligature in the orthodontic assembly of FIG. 1, according to some embodiments.

FIG. 4 is a side view of the installed ligature of FIG. 3, according to some embodiments.

FIG. 5 is a top view of the installed ligature of FIG. 3, according to some embodiments.

FIG. 6 is a schematic view of an orthodontic assembly including a bracket, an archwire, and a ligature, according to other embodiments.

FIG. 7 is a side view of the installed ligature in the orthodontic assembly of FIG. 6, according to other embodiments.

FIG. 8 is a superior view of the installed ligature of FIG. 7, according to other embodiments.

Like reference numbers represent like parts throughout.

### DETAILED DESCRIPTION

Orthodontists usually rely on various orthodontic devices to straighten and correctly align patients' teeth. These devices are generally referred to as braces. Braces generally include a plurality of brackets, an archwire, and a plurality of ligatures. The brackets are affixed to the teeth. The archwire closely contacts the brackets and applies force to move the teeth to a desired position. The ligatures secure the archwire to the bracket to prevent the archwire from displacement.

Generally, the brackets, the archwire, and the ligatures are exposed and conspicuous when viewed from the front of the teeth. Adolescents are typical patients who wear these orthodontic devices. It is desired that these orthodontic devices can be customizable, particularly in improving an aesthetic of the orthodontic devices, which may promote the use of the orthodontic devices. Some orthodontic devices have been made to achieve a particular aesthetic to provide a cosmetic or attractive effect. For example, the brackets can be made from ceramics having a less conspicuous or generally hidden appearance; the ligature can be made from transparent materials; or the like. However, complete exposure of the brackets and the archwires can make a satisfactory aesthetic less achievable, even at the cost of expensive materials. There exists demand of a better way to provide a satisfactory cosmetic or attractive effect at a reasonable cost.

Ligatures of these orthodontic devices can be conveniently replaced without disassembling the archwires and the brackets. The frequency with which these ligatures are replaced can vary. For example, the replacement can be completed at each appointment, e.g., approximately every 4-6 weeks.

A ligature is disclosed that includes a ligature member and a decorative member. The decorative member extends over and at least partially overlaps with the ligature member. When the ligature member is installed to a bracket that has been bonded to a tooth, the decorative member is generally disposed in front of the bracket and at least partially covers the bracket, the archwire, and the ligature member. Thereby, the decorative member can prevent the bracket, archwire, and ligature member from being completely exposed and conspicuous when viewed from the front of the tooth. The decorative member can, in some embodiments, provide a cosmetic and attractive effect based on, for example, its color, shape, material, pattern, etc. In some embodiments, the ligature including a decorative member as described in this specification can be provided at a cost that is relatively cheaper than other solutions.

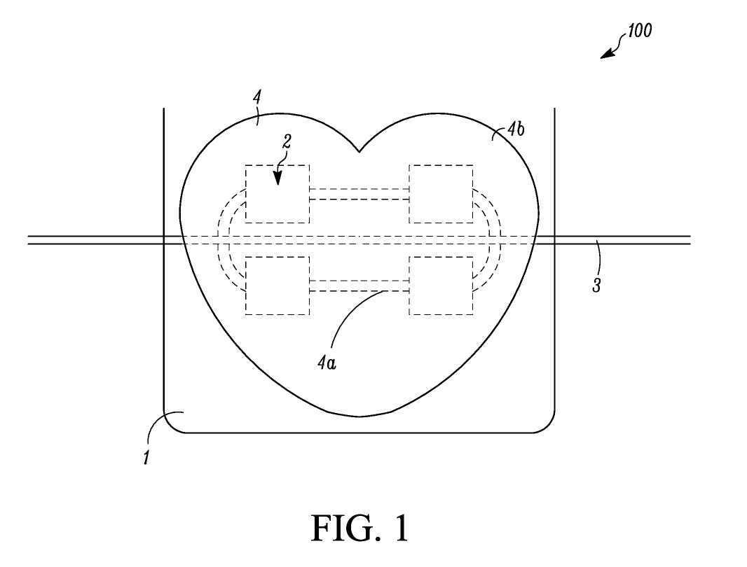

FIG. 1 is a schematic front view of an orthodontic assembly 100 including a bracket 2, an archwire 3, and a ligature 4, according to an embodiment. The ligature 4 includes a ligature member 4a and a decorative member 4b. The ligature 4 is installed on a bracket 2 that is affixed to a tooth 1 through ligature member 4a. The decorative member 4b is disposed in front of the bracket 2 relative to the tooth 1 and overlaps with the bracket 2. Thereby, the decorative member 4b can prevent at least the bracket 2 and ligature member 4a from being visible when viewed from the front of the tooth 1. The decorative member 4b has a heart shape in the illustrated embodiment, which can provide an attractive aesthetic. It will be appreciated that the decorative member 4b can be any shape without being particularly limited to a heart shape or the like.

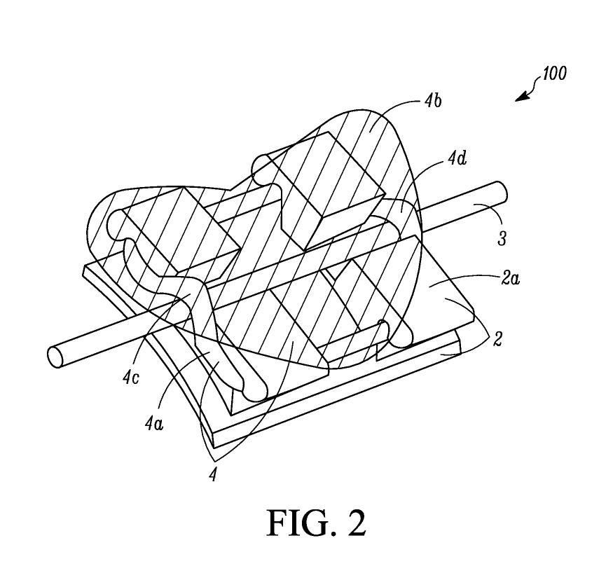

FIG. 2 illustrates a schematic view of the orthodontic assembly 100 including the bracket 2, the archwire 3, and the ligature 4, according to some embodiments.

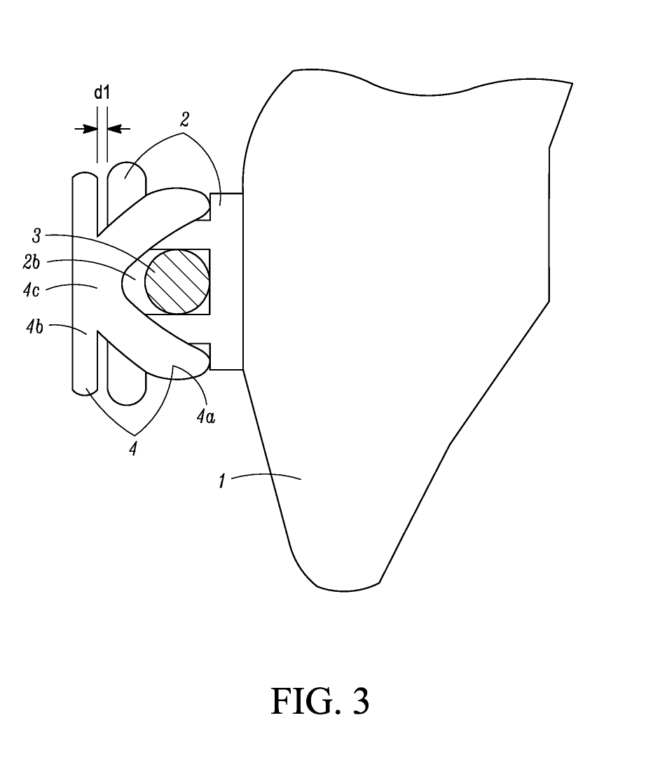

The illustrated bracket 2 is a conventional orthodontic bracket configured to have four tie wings 2a and an archwire slot (archwire slot 2b as shown and described in accordance with FIG. 3 below). The archwire 3 is disposed within the archwire slot. It will be appreciated that the bracket 2 can have a variety of designs and is not limited to the illustrated design. For example, the bracket 2 can include fewer tie wings 2a. Embodiments described herein are not limited to a particular design of the bracket 2. The archwire 3 conforms to a profile of upper or lower teeth and applies force to correct malpositioned teeth. It will be appreciated that the archwire 3 can be any type of orthodontic archwire. In some embodiments, the archwire 3 can be made of nickel titanium, stainless steel, copper nickel titanium, beta titanium, or the like. The material of the archwire 3 is not intended to be limiting. Any suitable material commonly used for braces may be used. Further, the archwire 3 is illustrated as having a circular cross section. It will be appreciated that the archwire 3 can have a variety of cross-sectional geometries such as, but not limited to, rectangular or the like.

As illustrated, the ligature 4 includes the ligature member 4a and the decorative member 4b. The ligature member 4a can hold the archwire 3 in an installed position in which the archwire 3 is retained in the archwire slot. The ligature member 4a can be a curved elastomeric elliptical torus in the illustrated embodiment. It will be appreciated that the ligature member 4a is not limited to this curved elastomeric elliptical torus. In some embodiments, the ligature member 4a can be planar. Without limitation, the ligature member 4a can also be a band, a loop, a plate with openings, etc. A cross section of the ligature member 4a can be any shape, such as, but not limited to, round, oval, elliptical, trefoil, quatrefoil, or polygons including triangular, rectangular, kite-shaped, rhombus-shaped, pentagonal, hexagonal, heptagonal, octagonal, diamond-shaped, etc. In some embodiments, the ligature member 4a can also be a rectangular shape with four openings in fit with the four tie wings of the bracket. The ligature member 4a can be any color including transparent.

Materials for making the ligature member 4a include, but are not limited to, polymers, metals, composite material, natural fibers, or the like. In some embodiments, the ligature member 4a can be made from an elastic polymer which is compatible with the environment of the mouth and safe for use in the mouth. Materials suitable for the ligature member 4a can include, but are not limited to, thermoplastic rubber polymers, silicon materials, α-olefin thermoplastics, fluoroelastomers, polyureas, polyurethanes, polyurethane/ureas, or suitable combinations of the forgoing. In some embodiments, the materials can include additives such as chemical or photochemical polymerization initiators, stabilizers, antioxidants, extending or reinforcing fillers, viscosity modifiers, surface tension modifiers, wetting aids, toughening agents, etc. In some embodiments, the materials can also include colorants such as dye or pigments. In some embodiments, the elastic polymer can be a medical grade polymer. In some embodiments, the ligature member 4a can additionally include a coating such as, but not limited to, an anti-microbial coating that can, in some embodiments, help reduce or prevent the adverse effects of bacterial colonization and action.

The decorative member 4b of the installed ligature 4 is disposed on a surface of the bracket 2 that is disposed relatively farther from the tooth than the bracket 2, and partially covers the surface of the bracket 2 where the ligature member 4a and the archwire 3 are disposed. In some embodiments, the decorative member 4b can fully cover the bracket and prevent it from being visible when viewed from the front of the teeth.

The decorative member 4b is heart-shaped in the illustrated embodiment. It will be appreciated that the decorative member 4b can have any shape. In some embodiments, the decorative members can have a shape related to a sport including a sports ball, a sports tool, a sports apparatus, a sports event, etc. Without limitation, the sports ball can be a basketball, a volleyball, a baseball, a ping-pong ball, a tennis ball, a football, a soccer ball, a golf ball, etc. Other examples include but are not limited to a star, a mascot, a moon, a sphere, a square, a cycle, an oval, an ellipse, a quatrefoil, a trefoil, a cross, a symbol, an alphabetic character, a number, any polygons including a triangle, a rectangle, a kite, a rhombus, a pentagon, a hexagon, a heptagon, an octagon, a diamond, etc. In some embodiments, the decorative member 4b can be suitable combinations of the foregoing shapes. In some embodiments, the decorative member 4b can have a profile of an animal, a mascot, a cartoon, a figure, a human body, a plant, a flower, a fruit, a tooth crown, or any other suitable object.

The decorative member 4b is a sheet with a continuous solid surface in the illustrated embodiment. In some embodiments, the decorative member 4b may not be a continuous sheet of material. For example, in some embodiments, the decorative member 4b can be a sheet having openings or apertures. It will be appreciated that the decorative member 4b is not limited to a sheet. The decorative member 4b can have a thickness. In some embodiments, the decorative member can include 3-D shapes; examples include, but are not limited to an octahedron, a hemisphere, a dodecahedron, a pyramid, a cylinder, a cube, a cone, etc., or combinations of thereof. Without limitation, the decorative member 4b can also be, e.g., a band, a ring, a plate, a charm, etc. The decorative member 4b can have any color, and can, in some embodiments, include more than one color. In some embodiments, the decorative member 4b can be transparent. In some embodiments, the decorative member 4b can have the same color as the teeth on which it is to be installed. In some embodiments, the surface of the decorative member 4b can be used to present attractive or cosmetic patterns. Examples of such patterns include but are not limited to smiley faces, cartoons, figures, drawings, photos, paintings, symbols, alphabets, numbers, icons, words, etc. It will be appreciated that the decorative member 4b can also include suitable combinations of the foregoing.

Materials for making the decorative member 4b include, but are not limited to polymers, composite materials, ceramic materials, natural fibers, metals, or the like. The decorative member 4b is preferably made from an elastomer, more preferably from a medical grade elastomer. In some embodiments, the decorative member 4b or even the whole ligature can be made of an Elastollan® material, for example, Elastollan® 1190A, available from BASF Polyurethanes GmbH. In some embodiments, the decorative member 4b can be made of the same materials as the ligature member 4a. In some embodiments, the decorative member 4b can additionally include a coating such as, but not limited to, an anti-microbial coating that can, in some embodiments, help reduce or prevent the adverse effects of bacterial colonization and action.

The ligature member 4a and the decorative member 4b can be a one-piece unitarily formed construction. It will be appreciated that the ligature and decorative members can also be manufactured separately, and then assembled together to form the ligature 4, e.g., during manufacturing, before or after installation of the ligature member. In some embodiments, the ligature 4 can additionally have a connection member connecting the ligature member 4a to the decorative member 4b. In some embodiments, the connection member, the decorative member 4b, and the ligature member 4a can be unitary one-piece construction (e.g., being formed of a single elastomer). In some embodiments, the connection member can be integrated with either ligature member 4a or the decorative member 4b. In some embodiments, the three members can be separate members. If the above three members are not a unitary piece, they can be assembled together before or after installation of the ligature member to the bracket. The connection member can be, for example, made from polymers, composite materials, ceramic materials, natural fibers, and metals. In some embodiments, the connection member can be made from elastomers. In some embodiments, the connection member can be made from medical grade elastomers. The connection member can, for example, be made of the same material as the ligature member 4a and the decorative member 4b, according to some embodiments. In other embodiments, the connection member can be made of a different material than the ligature member 4a, the decorative member 4b, or both of the ligature member 4a and the decorative member 4b.

The decorative member 4b is connected to the ligature member 4a at portions 4c and 4d of the ligature (also shown in FIGS. 3-5). Accordingly, the number of connections between the decorative member 4b and the ligature member 4a is two in the illustrated embodiment. It will be appreciated that the number of connections between the decorative member 4b and the ligature member 4a is not limited to two. In some embodiments, the number of connections between the decorative member 4b and the ligature member 4a can be one. In some embodiments, the number of connections between the decorative member 4b and the ligature member 4a can be three or more.

The connection portions 4c, 4d of the ligature, which connect the decorative member 4b to the ligature member 4a, can be aligned to about a left center and a right center of the bracket 2 in the illustrated embodiment. It will be appreciated that the connection portion(s) 4c, 4d of the ligature 4, which connect the decorative member 4b to the ligature member 4a, can be aligned to any location(s) relative to the bracket 2. In some embodiments, the connection portion(s) 4c, 4d of the ligature 4 can be aligned to about a top center and a bottom center of the bracket 2. In some embodiments, the decorative member 4a can be indirectly connected to the ligature member 4b through a connection member. The connection member can be aligned to any location(s) relative to the bracket 2, e.g., about a top center, about a bottom center, about a left center, or about a right center of the bracket 2.

In some embodiments, the decorative member 4b can further include a sticker member. The sticker member can be adhered to the outermost surface of the decorative member 4b. In such embodiments, the decorative member 4b can be, for example, a solid surface upon which the sticker member can be secured. The sticker member can be used to present attractive or cosmetic patterns. The sticker member can have a more intricate design or coloring, in addition to the shapes and the colors discussed for the decorative member, which are described in this specification. The sticker member can be made of polymers, fibers, ceramics, metals, etc. In some embodiments, the sticker member and any adhesive used to fix the sticker member to the decorative member 4b are selected to be compatible with the environment of the mouth, and safe for use in the mouth. Without limitations, the sticker member can be adhesive film, pad, plate, etc.

A method for manufacturing the ligature can include molding the ligature member 4a and the decorative member 4b. If the ligature member 4a and the decorative member 4b are not one-piece unitarily formed construction, the method can further include assembling the ligature member 4a and the decorative member 4b into one piece. The method may include coating the ligature member 4a and/or the decorative member 4b with a polymeric film that may help to reduce the color degradation during its actual use. The method may also include coating the ligature member 4a and/or the decorative member 4b with a coating, including but not limited to an anti-microbial coating that can, in some embodiments, help reduce or prevent the adverse effects of bacterial colonization and action.

FIG. 3 is a side view of the installed ligature 4, according to some embodiments. The bracket 2 is affixed to the tooth 1. The archwire 3 is inserted into the archwire slot 2b, and can apply force to the bracket 2 to align the tooth to a desired position. The illustrated ligature 4 appears like a “K” in this side view of the illustrated embodiment. The decorative member 4b of the ligature 4 is disposed in front of the bracket 2 relative to the tooth 1 and at least partially covers the bracket 2 from being completely exposed when viewed from the front of the tooth 1. In some embodiments, the decorative member 4b can be in contact with the surface of the bracket 2 such that there is substantially no gap formed therebetween. In some embodiments, the decorative member 4b may be disposed away from the bracket 2 such that a gap is formed therebetween. The gap can have a width d1. In some embodiments, the width d1 is less than about 2 mm. In some embodiments, the width d1 is less than about 1 mm. In some embodiments, the width d1 is less than about 0.5 mm.

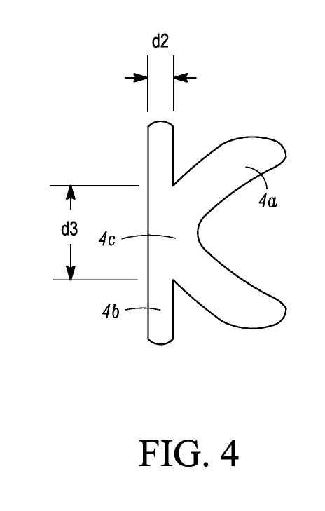

FIG. 4 is a side view of the ligature 4 of FIG. 3, according to some embodiments. The illustrated ligature 4 appears in a “K” shape. The decorative member 4b is connected to the ligature member 4a at portions 4c and 4d of the ligature member 4a. The portion 4d is not shown in FIG. 4, but can be seen in FIGS. 2 and. 5. The connection portions 4c, 4d are aligned to about the left and the right horizontal centers of the affixed bracket in this illustrated embodiment (see FIGS. 2 and 3). The decorative member 4b has a thickness d2. In some embodiments, the thickness d2 can be less than about 2 mm. In some embodiments, the thickness d2 can be less than about 1.5 mm. In some embodiments, the thickness d2 can be less than about 1 mm. The connection portion 4c, 4d can have a dimension d3 at which the connection is made between the decorative member 4b and the ligature member 4a. The dimension d3 can be in a range from at or about 0.5 mm to at or about 2 mm.

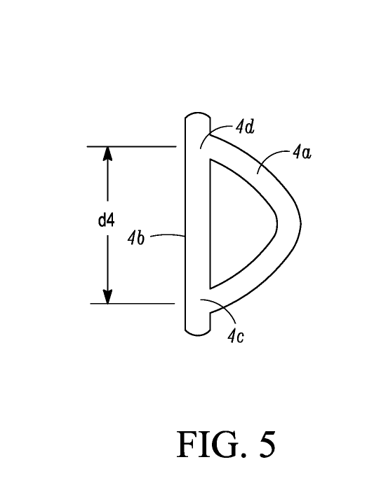

FIG. 5 is a top view of the ligature 4 of FIG. 3, according to some embodiments. The illustrated ligature 4 appears like a “D” shape when viewed in the top view. The ligature member 4a is connected to the decorative member 4b at portions 4c and 4d of the ligature 4. The ligature member 4a has a dimension d4 which can, in some embodiments, correspond to a diameter of the ligature member 4a. In general, the dimension d4 is selected such that the ligature member 4a can be fit over the bracket 2 (FIGS. 2-3) and secure the archwire 3 in place. In some embodiments, the dimension d4 can range from at or about 1 mm to at or about 5 mm.

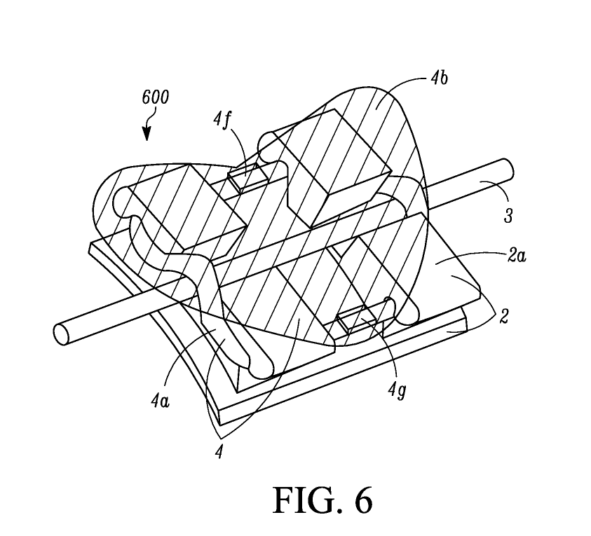

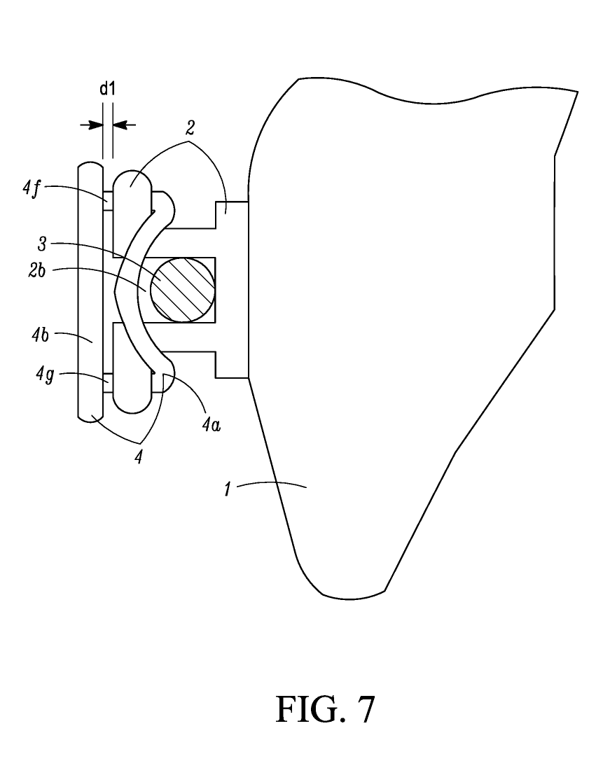

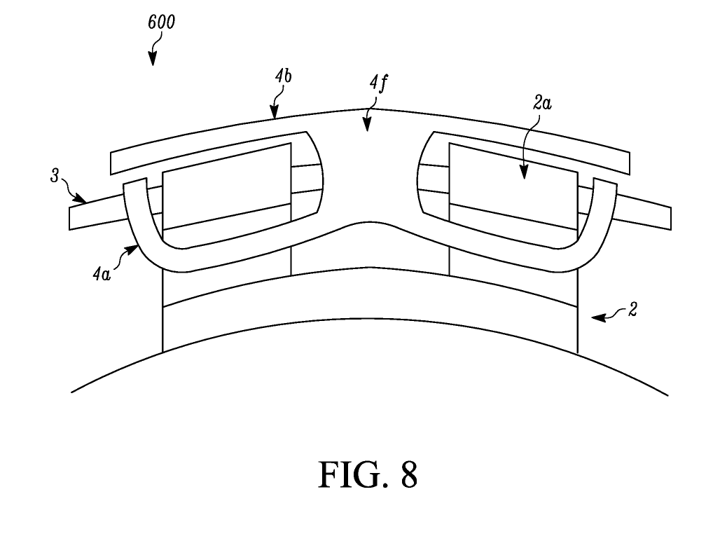

FIG. 6 is a schematic view of an orthodontic assembly 600 including the bracket 2, the archwire 3, and the ligature 4, according to other embodiments. The embodiment illustrated in FIG. 6 differs from the embodiment illustrated in FIG. 2 mainly in the locations where the decorative member 4b is connected to the ligature member 4a. The decorative member 4b is connected to the ligature member 4a at portions 4f and 4g of the ligature (also shown in FIGS. 7 and 8). The connection portions 4f, 4g of the ligature 4, which connect the decorative member 4b to the ligature member 4a, are aligned to about a top center and a bottom center of the bracket 2 in the illustrated embodiment of FIG. 6. In some embodiments, the decorative member 4a can be indirectly connected to the ligature member 4b through a connection member.

FIG. 7 is a side view of the installed ligature 4 in the orthodontic assembly 600 of FIG. 6, according to some other embodiments. The embodiment illustrated in FIG. 7 differs from the embodiment illustrated in FIG. 3 mainly in the locations where the decorative member 4b is connected to the ligature member 4a. The decorative member 4b is connected to the ligature member 4a at portions 4f and 4g of the ligature, which are respectively disposed at about a top center and a bottom center of the bracket 2 in the illustrated embodiment. The decorative member 4b of the ligature 4 is disposed in front of the bracket 2 relative to the tooth 1 and at least partially covers the bracket 2 from being completely exposed when viewed from the front of the tooth 1. In some embodiments, the decorative member 4b can be in contact with the surface of the bracket 2 such that there is substantially no gap formed therebetween. In some embodiments, the decorative member 4b may be disposed away from the bracket 2 such that a gap is formed therebetween.

FIG. 8 is a superior view of the installed ligature 4 of FIG. 7, according to other embodiments. This superior view provides a close-in view of the installed ligature 4 of FIG. 7 when viewed from the top of the bracket 2. The ligature 4 includes ligature member 4a and decorative member 4b. The ligature 4 further includes a connection portion 4f aligned at about the top center of the bracket 2. The illustrated bracket 2 is a conventional orthodontic bracket configured to have four tie wings 2a. It will be appreciated that the bracket 2 can have a variety of designs and is not limited to the illustrated design. For example, the bracket 2 can include fewer tie wings 2a. Embodiments described herein are not limited to a particular design of the bracket 2. The archwire 3 is disposed within an archwire slot and conforms to the profile of teeth applying force to correct malpositioned teeth.

A method for installing an elastomeric ligature member can include the following steps. The ligature may be gripped by a forceps or tweezer and moved toward the tooth, and then slightly downwardly to position a leading edge of the ligature behind the tie wing. The gripped end of the ligature can be moved downwardly over the archwire and toward the tooth so the gripped end of the elongated and tensioned ligature can be snapped in place behind a lower tie wing of the bracket. Additionally, the new ligature can be adjusted so the decorative member is positioned appropriately.

Aspects:

It will be appreciated that any one of aspects 1 to 29 may be combined with any one of aspects 30-31 and 32-33. Further, any one of aspects 30-31 can be combined with any one of aspects 32-33.

Aspect 1. An orthodontic ligature, comprising:

a ligature member; and

a decorative member,

wherein the decorative member is connected to the ligature member and extends over the ligature member.

Aspect 2. The orthodontic ligature according to aspect 1, further comprising a connection member, wherein the connection member connects the ligature member to the decorative member.

Aspect 3. The orthodontic ligature according to any one of aspects 1-2, wherein the decorative member of an installed ligature is disposed in front of an outermost surface of an orthodontic bracket bonded to a tooth and at least partially covers the orthodontic bracket.

Aspect 4. The orthodontic ligature according to any one of aspects 1-3, wherein the ligature member is curved.

Aspect 5. The orthodontic ligature according to any one of aspects 1-4, wherein the ligature member is an elastomer.

Aspect 6. The orthodontic ligature according to any one of aspects 1-5, wherein the ligature member is planar.

Aspect 7. The orthodontic ligature according to any one of aspects 1-6, wherein the ligature member has a polygon shape.

Aspect 8. The orthodontic ligature according to any one of aspects 1-7, wherein the ligature member is a band.

Aspect 9. The orthodontic ligature according to any one of aspects 1-8, wherein the decorative member is colored.

Aspect 10. The orthodontic ligature according to any one of aspects 1-9, wherein the decorative member has a heart shape.

Aspect 11. The orthodontic ligature according to any one of aspects 1-10, wherein the decorative member has a star shape.

Aspect 12. The orthodontic ligature according to any one of aspects 1-11, wherein the decorative member has a moon shape.

Aspect 13. The orthodontic ligature according to any one of aspects 1-12, wherein the decorative member has a polygon shape.

Aspect 14. The orthodontic ligature according to any one of aspects 1-13, wherein the ligature member has a quatrefoil shape.

Aspect 15. The orthodontic ligature according to any one of aspects 1-14, wherein the ligature member has a trefoil shape.

Aspect 16. The orthodontic ligature according to any one of aspects 1-15, wherein the decorative member is a cartoon.

Aspect 17. The orthodontic ligature according to any one of aspects 1-16, wherein the decorative member has a smiley face on its outmost surface.

Aspect 18. The orthodontic ligature according to any one of aspects 1-17, wherein the decorative member has a picture on its outmost surface.

Aspect 19. The orthodontic ligature according to any one of aspects 1-18, wherein the decorative member has an alphabet character on its outmost surface.

Aspect 20. The orthodontic ligature according to any one of aspects 1-19, wherein the decorative member has a symbol on its outmost surface.

Aspect 21. The orthodontic ligature according to any one of aspects 1-20, wherein the decorative member has a number on its outmost surface.

Aspect 22. The orthodontic ligature according to any one of aspects 1-21, wherein the decorative member has a sport-related shape.

Aspect 23. The orthodontic ligature according to any one of aspects 1-22, wherein the decorative member has a baseball shape.

Aspect 24. The orthodontic ligature according to any one of aspects 1-23, wherein the decorative member has a football shape.

Aspect 25. The orthodontic ligature according to any one of aspects 1-24, wherein the decorative member has a basketball shape

Aspect 26. The orthodontic ligature according to any one of aspects 1-25, further comprising:
a sticker member, wherein the sticker member is adhered to the surface of the decorative member.

Aspect 27. The orthodontic ligature of aspect 26, wherein the sticker member is an adhesive pad.

Aspect 28. The orthodontic ligature of aspect 26, wherein the sticker member is an adhesive film.

Aspect 29. An elastomeric orthodontic ligature, comprising:
a ligature member; and
a decorative member, wherein the decorative member is connected to the ligature member and extends over the ligature member,
wherein the ligature and the decorative member being unitarily formed on an elastomer.

Aspect 30. The elastomeric orthodontic ligature of aspect 29, further comprising:
a connection member,
wherein the connection member connects the ligature member and the decorative member, and the connection member is unitarily formed on an elastomer together with the ligature member and the decorative member.

Aspect 31. The elastomeric orthodontic ligature of aspect 29, further comprising:
a sticker member,
wherein the sticker member can be adhered to the surface of the decorative member.

Aspect 32. A method for installing the ligature according to claim 1, comprising steps of installing the ligature to the bracket; adjusting the orientation of the decorative member.

Aspect 33. A method of making the ligature according to claim 1, comprises molding the decorative member and the ligature member of the ligature.

It is noted that the features of different aspects or embodiments of the disclosure may be combined in any way and/or combination. The omission in the above aspects of any subject matter that is disclosed herein is not a disclaimer of such subject matter, nor should it be regarded that the inventors did not consider such subject matter to be part of the disclosed inventive subject matter.

The terminology used in this specification is intended to describe the particular embodiments and is not intended to be limiting. The use of the terms “a”, “an”, “the” and their plural forms to describe elements, components, ingredients or steps is not intended to foreclose additional elements, components, ingredients or steps. The terms “comprises,” “comprising,” and/or “comprised,” when used in this specification and aspects, specify the presence of the stated elements, ingredients, components or steps, but do not preclude the presence or addition of one or more other elements, ingredients, components or steps. The use of the term “about” in connection with two locations applies to both locations. For example, about the left center and the right center means about the left center and about the right center.

With regard to the preceding description, it is to be understood that changes may be made in detail, especially in matters of the construction materials employed and the shape, size, and arrangement of parts without departing from the scope of the present disclosure. This specification and the embodiments described are exemplary only.

What is claimed is:

1. An orthodontic ligature, comprising:
a ligature member; and
a decorative member,
wherein the decorative member is connected to the ligature member and extends over the ligature member.

2. The orthodontic ligature according to claim 1, further comprising a connection member, wherein the connection member connects the ligature member to the decorative member.

3. The orthodontic ligature according to claim 1, wherein the decorative member of an installed ligature is disposed in front of an outermost surface of an orthodontic bracket bonded to a tooth and at least partially covers the orthodontic bracket.

4. The orthodontic ligature according to claim 1, wherein the ligature member is curved.

5. The orthodontic ligature according to claim 1, wherein the ligature member is an elastomer.

6. The orthodontic ligature according to claim 1, further comprising:
a sticker member, wherein the sticker member is adhered to a surface of the decorative member.

7. The orthodontic ligature according to claim 6, wherein the sticker member includes an adhesive film.

8. An elastomeric orthodontic ligature, comprising:
a ligature member; and
a decorative member, wherein the decorative member is connected to the ligature member and extends over the ligature member,
wherein the ligature and the decorative member are unitarily formed of an elastomer.

9. The elastomeric orthodontic ligature according to claim 8, further comprising:
a sticker member,
wherein the sticker member is adherable to a surface of the decorative member.

10. The elastomeric orthodontic ligature according to claim 8, further comprising:
a connection member,
wherein the connection member connects the ligature member and the decorative member, and the connection member is unitarily formed of an elastomer together with the ligature member and the decorative member.

11. The elastomeric orthodontic ligature member according to claim 10, wherein the connection member includes a plurality of connection members.

12. The elastomeric orthodontic ligature member according to claim 11, wherein the connection member includes two connection members disposed such that in an installed state, the connection members are disposed on a top and a bottom of an orthodontic bracket bonded to a tooth.

13. The elastomeric ligature member according to claim 11, wherein the connection member includes two connection members disposed such that in an installed state, the connection members are disposed on a left side and a right side of an orthodontic bracket bonded to a tooth when viewed from a front of the tooth.

14. The elastomeric orthodontic ligature member according to claim 8, wherein when in an installed state, the decorative member is disposed in front of an outermost surface of an orthodontic bracket bonded to a tooth and at least partially covers the orthodontic bracket.

15. The elastomeric ligature member according to claim 8, wherein when in an installed state, the decorative member is disposed in front of an outermost surface of an orthodontic bracket bonded to a tooth and the decorative member is relatively larger than the orthodontic bracket such that the orthodontic bracket is blocked from a front view of the tooth.

16. The elastomeric ligature member according to claim 8, wherein the decorative member is planar.

17. The elastomeric ligature member according to claim 8, wherein the ligature member and the decorative member further comprise an antimicrobial coating.

18. The elastomeric ligature member according to claim 8, wherein the decorative member includes one or more apertures.

19. A method of manufacturing the ligature according to claim 1, comprising:
molding the decorative member and the ligature member of the ligature.

20. The method of manufacturing according to claim 19, wherein the decorative member and the ligature member are molded using an elastomer.
